(19) United States
(12) Patent Application Publication
(10) Pub. No.: US 2014/0067434 A1
(43) Pub. Date: Mar. 6, 2014

(54) Methods and Systems for Providing Risk Profile Analytics

(71) Applicant: Agero, Inc., Medford, MA (US)

(72) Inventors: Julian J. Bourne, Weston, MA (US); Christopher Annibale, Malden, MA (US)

(73) Assignee: Agero, Inc., Medford, MA (US)

(21) Appl. No.: 14/013,436

(22) Filed: Aug. 29, 2013

Related U.S. Application Data
(60) Provisional application No. 61/695,130, filed on Aug. 30, 2012.

(51) Int. Cl. G06Q 40/08

(52) U.S. Cl. CPC G06Q 40/08
USPC 705/4

(57) ABSTRACT

A risk profile system determines a risk profile of a driver of a vehicle using improved driver metrics. Driver characteristics of a driver are determined as the driver encounters one or more locations that have an associated weighted accident history. The determined driver characteristics of the driver are compared to a normal distribution curve of driving characteristic data at one or more of the locations encountered by the driver.

A risk profile system determines improved driver metrics. A weighted accident history is determined for one or more locations. A normal distribution curve is determined for driving characteristic data of a plurality of drivers at each of the one or more locations.

### CROSS-REFERENCE TO RELATED APPLICATIONS

This application claims priority to U.S. Provisional Application Ser. No. 61/695,130, filed on Aug. 30, 2012, the entire disclosure of which is hereby incorporated herein in its entirety.

### FIELD OF THE INVENTION

The present invention lies in the field of insurance. The present disclosure relates to methods and systems related to usage-based insurance.

### BACKGROUND OF THE INVENTION

In order to calculate insurance pricing, insurance companies use various measures to determine a risk profile of an insured. Insurance companies have traditionally used relatively arbitrary variables to determine consumer risk profiles and insurance pricing. Examples of these variables include: home location, age, sex, and driving record.

With usage-based insurance (UBI) and Pay As You Drive (PAYD) insurance programs, insurance companies are trying to improve the correlation of these variables to the actual quality of the driver. Safe drivers are considered to have a lower risk of damaging their vehicle and, therefore, are less likely to file a claim on their insurance policy.

On-Board Diagnostics (OBD) devices can be plugged into the OBD port of a vehicle to capture data relating to mileage, hard breaking, vehicle location, speeding, time of travel, aggressive acceleration, and others.

A Driverscore is a quantifiable mechanism used by insurance industry underwriters to categorize driver quality. Usage-based insurance analyzes OBD data to determine Driverscore. For instance, incidences of hard braking, e.g., reducing speed at greater than 7 miles-per-hour/second, is flagged as an example of aggressive driving, which is one characteristic for decreasing the Driverscore. Each of the OBD variables is assigned a weighting, or coefficient, according to its importance, and multi-variant regression analysis is utilized to calculate policy holder Driverscores.

A problem with raw telemetry data is that it is often too coarse of an indicator of actual driving quality. In the above example, hard braking may have been actually necessary in order to avoid a car that unexpectedly pulled in front of the driver—in which case, the driver may have displayed excellent driving skills to avoid a crash. That driver will, nevertheless, be penalized because this incorrect indication of driving quality actually contributed towards paying a higher insurance premium.

Another issue with UBI data is that insurance underwriting risk factors for insurance premiums are based on self-reported location data of the individual and the underlying asset (e.g., vehicle). This self-reporting aspect presents significant potential for inaccuracies in the underwriting process because a customer may be tempted to report inaccurate location data (e.g., place of garaging, primary residence, use, travel patterns).

One problem with inaccurate location data is that risks cannot be anticipated through the underwriting process. The inability to anticipate these risks can result in unpredictable excessive claims.

Thus, a need exists to overcome the problems with the prior art systems, designs, and processes as discussed above.

### FIELD OF THE INVENTION

The invention provides methods for determining and/or using improved driver metrics that overcome the hereinafore-mentioned disadvantages of the heretofore-known devices and methods of this general type and that provide such features with a system for collecting, weighting, and comparing data.

With the foregoing and other objects in view, there is provided, in accordance with the invention, a method for determining a risk profile of a driver of a vehicle using improved driver metrics. Driver characteristics of a driver are determined as the driver encounters one or more locations that have an associated weighted accident history. The determined driver characteristics of the driver are compared to a normal distribution curve of driving characteristic data at one or more of the locations encountered by the driver.

In accordance with another mode of the invention, the determined characteristics of the driver can be at least one of speed, time of day, acceleration, braking, an amount of times that brakes are used, and an amount of times that the driver accelerates.

In accordance with a further mode of the invention, the normal distribution curve accounts for current or historical weather conditions at the one or more locations.

In accordance with an added mode of the invention, the normal distribution curve accounts for traffic conditions at the one or more locations.

In accordance with an additional mode of the invention, driver competence is determined by providing a comparison of driver characteristics of the driver with driver characteristic data of different drivers in similar situations.

In accordance with yet another mode of the invention, driver competence is determined by providing a comparison of driver characteristics of the driver in different weather conditions.

In accordance with yet a further mode of the invention, the driver is given advance warning of bad driving conditions.

In accordance with yet an added mode of the invention, the driver characteristic data of the driver is examined to determine whether driving behavior of the driver changes based on the advance warning.

In accordance with yet an additional mode of the invention, positional information of the vehicle is obtained.

In accordance with again another mode of the invention, weather data is associated with the positional information of the vehicle.

In accordance with again a further mode of the invention, traffic data is associated with the positional information of the vehicle.

In accordance with again an added mode of the invention, accidents of the weighted accident history are classified by frequency or type to determine severity ratings.

In accordance with again an additional mode of the invention, the severity ratings are a function of variables including whether the accidents of the accident history are at least one of driver-caused, related to weather, and related to distracted driving.

In accordance with still another mode of the invention, the weighted accident history is used to determine metrics for a route.

In accordance with still a further mode of the invention, data is collected using a mobile device of the driver.

In accordance with still an added mode of the invention, the collected data is used to determine whether the driver is distracted.

In accordance with still an additional feature of the invention, a weighted accident history is determined for the one or more locations and the normal distribution curve is determined for driving characteristic data of a plurality of drivers at each of the one or more locations.

With the objects of the invention in view, there is also provided a method for providing improved driver metrics. A weighted accident history is determined for one or more locations. A normal distribution curve is determined for driving characteristic data of a plurality of drivers at each of the one or more locations.

In accordance with another mode of the invention, the driving characteristic data can be at least one of speed, time of day, acceleration, braking, an amount of times that brakes are used, and an amount of times that the drivers accelerate.

In accordance with a further mode of the invention, the normal distribution curve determining step is carried out by having the normal distribution curve account for weather conditions at the one or more locations.

In accordance with a concomitant feature of the invention, the normal distribution curve determining step is carried out by having the normal distribution curve account for traffic conditions at the one or more locations.

Although the invention is illustrated and described herein as embodied in a risk profile system, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block diagram of a risk profile system according to an exemplary embodiment; and

FIG. 2 is a block diagram of Application Programming Interfaces according to an exemplary embodiment.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

Described now are exemplary embodiments of the present invention.

### Comparative Driving Behavior Method

Insurance pricing is measured on a sliding scale from low to high risk. There are two main industry constraints: 1) insurance is competitive and highly commoditized; and 2) insurance premiums need to cover claim losses. These constraints force the insurance industry to get smarter about determining a risk profile of an insured, e.g., a driver. The idea behind a “smarter” insurance industry is that low-risk policy holders should pay less, especially given the fact that 25% of the driving market accounts for 50% of the insurance claims.

As stated previously, one mechanism to obtain a risk profile for a vehicle driver is the Driverscore, which looks at various driving behaviors and characteristics and weighs some higher than others using multivariate regression curves for price-versus-risk. Some of the measured variables in UBI include: number of miles driven, instances of hard braking, location of vehicle, distance, time of day, city/town, incidents of speeding, incidents of hard acceleration, and swerving/lane hopping. Currently, only a coarse measurement, i.e., a frequency, of the above-mentioned variables, is determined. However, especially with respect to hard braking, speeding, and lane variation, this coarse measurement is not a valid measure of driving ability. In some instances, what may be considered “bad” driving arrived at from coarse measurement data may actually represent a driver who is using excellent ability and fast reflexes to avoid a situation that, otherwise, would be an accident. A good driver with fast reflexes may actually be penalized for this ability when coarse measurements are used.

The insurance consumer is presently being told that accelerating/weaving/hard braking is an indicator of bad driving behavior. This assertion of bad driving behavior, even in instances where the driving behavior is an indication of good driving, is not popular with the insurance consumer. Thus, there is a need for metrics that are better suited to the driver and over which the driver has control.

Methods to determine improved metrics are disclosed herein. Data regarding a history of accidents or clusters of accidents in certain areas is collected. The accidents are weighted. The weighted accident history for each area or location is considered data on “black spots.” A normal distribution curve of speed, hard braking, hard acceleration, etc. may be determined for each black spot. The method determines driving characteristics, e.g. UBI data, of drivers as they encounter various black spots. For example, the method considers a route that a driver habitually takes. The route may include one or more black spot intersections. As the driver encounters each black spot, driving characteristics of the driver are determined. The driving characteristics include, but are not limited to, speed, time of day, acceleration, braking, an amount of times that brakes are used, and an amount of times that the driver accelerates. The determined driving characteristics of the driver are then compared with a normal distribution curve for that black spot in order to provide a better, and more refined, risk profile for the driver.

The risk profile can also take weather conditions into account. This can be separate from or in addition to the black spot analysis. A distribution curve can be adjusted to account for “good” weather conditions, e.g., dry or sunny, and “bad” weather conditions, e.g., rainy, foggy, snowy, etc. This additional data provides a better indication of driver competence in different driving conditions by: 1) providing a comparison of the driver with different drivers in similar situations; and 2) providing a comparison of the same driver in good or bad weather conditions.

In one exemplary embodiment, the driver can be given advance warning of bad conditions and, based upon providing this information, the UBI device/methods will examine the driver to see if driving behavior is changed as a result. More particularly, the risk profile can take into account whether a driver drives more responsibly in black spots and/or in poor weather as a result of receiving a warning of bad conditions.

Weather data can be obtained from an application programming interface (API). For example, one API provided by the National Oceanic and Atmospheric Association (NOAA) that gives historic/current/future weather conditions by the hour for current zip codes can be used. Real-time radar mapping can augment the resolution of this zip code information in order to provide very localized knowledge. A relational database is used to obtain the vehicle's GPS coordinates and, using the API, can associate the current GPS coordinates with weather conditions. This can also be extended to include a driver's current or active turn-by-turn navigation to give the driver even further future information as defined below.

In one exemplary embodiment, the driver's global positioning system (GPS) coordinates are determined. A zip code API determines a current zip code associated with these GPS coordinates. The zip code and time of day are then entered into the NOAA API in order to obtain historic/current/future weather conditions.

Traffic data can also be taken into account through a traffic data API. Similarly, a relational database is used to obtain the vehicle's GPS coordinates for the vehicle and its route. The GPS coordinates are assigned to a location on a road by matching these GPS coordinates to the map contained in the database. Each section or segment of the road has an associated traffic speed, which can be used as one indicator to determine whether the driver is driving safely relative to other drivers.

Traffic APIs allow for the determination of the present/real-time traffic speed using different sources of data. The sources of data may be speed-measuring strips located on a road, a live speed determined from data obtained from in-vehicle probes, and speed data obtained from mobile phones, to name a few. One example of a traffic data API is provided by Google Maps™. The Google Maps™ API can determine a live speed from in-vehicle probes or receive information from phones using the Google® mobile operating system.

Black spot data, as stated previously, refers to data regarding a history of accidents or a cluster of accidents. Black spot data can be collected by roadside assistance providers (towing companies) who log the location of the accident and tow the vehicle away. Black spot data can also be obtained from police or other emergency responders. Accidents can be classified by frequency or type in order to determine severity ratings, which can be a function of different variables such as driver-caused, weather-contributed, texting/cell use, etc. Historical weather data be correlated to accident data in order to adjust the black spot distribution curve when local weather has adversely impacted the accident frequency or severity of a black spot. Black spot data can also be used to determine metrics for a route, for example, “accident per mile.”

UBI data is collected using on-board diagnostics (OBD) devices. Presently, OBD devices are either provided after-market or integrated with the vehicle. Present OBD devices have an integrated transceiver in order to communicate with UBI systems via a wireless network, e.g., a cellular network. Soon, OBD devices will be made without cellular network transceivers and will, instead, be able to communicate via a short-range wireless protocol, e.g., Bluetooth, using a paired mobile device of the user. In the future, separate OBD devices may be phased out in favor of collecting data using an OBD application on a user's mobile device or other mobile computing device. All of these data collection/transmitting technologies can be paired with the systems and methods described herein.

In one exemplary embodiment, when data is collected using a mobile device of a user (either paired with an OBD device or running an OBD application), the risk profile application can keep track of other applications that are being used on the mobile device. In this embodiment, the risk profile application can determine whether a user is distracted while driving, e.g., texting, emailing, or making a call without a headset.

A normal distribution curve can be determined for a plurality of variables (UBI, black spot, traffic, weather) in various locations. Statistical data, e.g., mean and standard deviation, can be determined for a certain data set at each location in order to determine where the driver's score is relative to the statistical data. Comparing the driver to the statistical data allows the risk profile application to determine if the driver's behavior adjusts (positively or negatively) when changes, such as black spot/traffic/weather, are imposed. Using this data achieves a better risk profile score, e.g., Driverscore.

### Location Based Driver Risk Analytics

The present method solves the problem of an insurance company underwriting risk based largely on self-reporting rather than actual location data. The present method enables more accurate risk profiling from data that better reflects risk than the aggregate location methods presently used. By providing actual location data, risk profiling becomes significantly more accurate. Location data can be obtained from an OBD device or from a user's mobile device. The risk profile application uses the location data to determine risks that would not be evident from self-reported data. In other words, the risk profile application ties location back to risk. Actual location data, in another exemplary embodiment, is used to determine whether the user frequents high crime areas or other behavior-changing areas, such as black spots.

Location data (including but not limited to GPS, WiFi, cellular network triangulation, or any combination thereof) is collected from various devices (vehicle telematics, vehicle tracking device, mobile phone, etc.) associated with a specific individual who has a specific asset for which insurance is sought. The collected data is processed and analyzed against location-based data sets for the purpose of identifying risk related to, but not limited to, specific points of interest (POI, e.g., businesses, parks, addresses), travel routes, classifications of location, weather, traffic, crime, etc. Once analyzed against the location based data sets, metrics are provided that define the specific risk of an individual and the associated asset against known location-driven risks.

POI data can be obtained to determine where users actually drive. Present UBI data only takes into account the actual mileage driven by a user but provides no granularity as to where the miles are being driven. The present systems and methods associate the actual mileage with location data in order to associate risk with the collected location data.

For example, using self-reporting, a user may report mileage “between home and work.” However, if the user takes public transportation to work and uses the allocated miles for pleasure driving, the risk is being mis-measured, especially where the user's pleasure driving miles occur in high-risk areas.

POI data can also be used to measure driving behavior and/or detect travel patterns. For example, it can be determined if a user frequents a bar every Friday night. It can also be determined whether driving behavior changes as a result of visiting certain POI or leaving a POI at a certain time, e.g., after lunch, or after 2 AM.

In one exemplary embodiment, the risk profile application can associate crime data with location-based risk. Crime data can be obtained from police reports. Crime data can also be obtained from claim loss reports used by insurance companies. Example claim loss databases are the A-Plus Report and the Comprehensive Loss Underwriting Exchange (CLUE). With respect to crime and claim loss data, the risk of the vehicle being stolen or broken into is associated with location data.

Presently, location data is derived from in-vehicle UBI data through OBD. As stated above, soon, OBD devices will be made without cellular network transceivers and will, instead, be able to communicate via a short-range wireless protocol, e.g., Bluetooth, using a paired mobile device of the user. In the future, separate OBD devices may be phased out in favor of collecting data using an OBD application on a user's mobile device or other mobile computing device.

Analyzing data of this type provides two opportunities for insurance companies. First, an insurance company can obtain a more accurate risk profile of its existing customers and, second, the insurance company can now attract customers based on their location specific risk profile by providing accurate location based insurance quotes in advance of the customer signing a policy.

### Risk Profile System

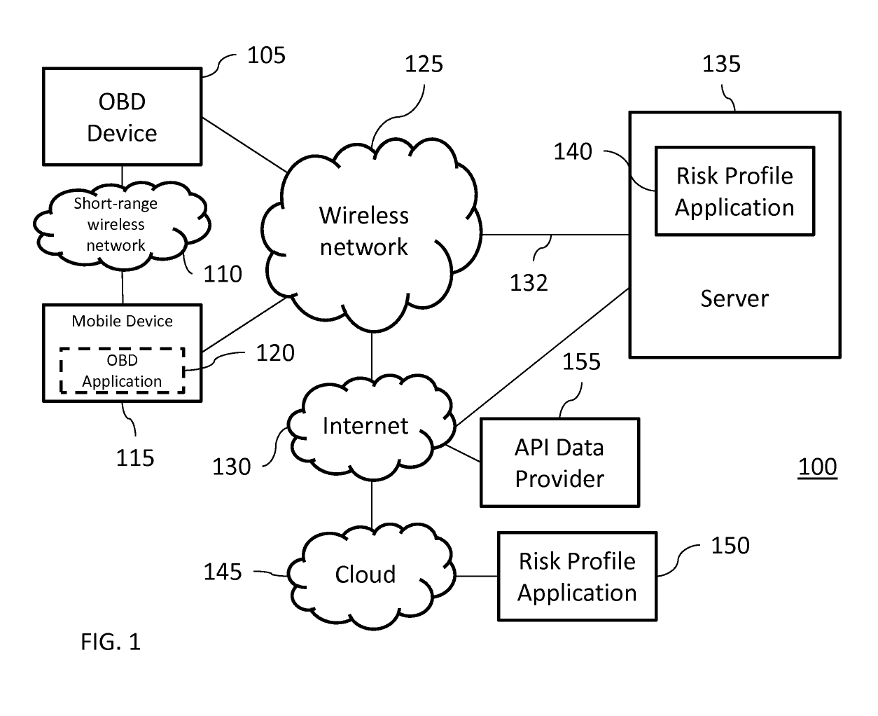

FIG. 1 illustrates a risk profile system 100, according to one exemplary embodiment. UBI and specific location data can be collected using OBD device 105. The OBD device 105 can be integral with a vehicle or can be an after-market device that is installed in the vehicle. OBD device 105 may be a stand-alone device having its own transceiver (not shown) for communicating with a wireless, e.g., cellular, network 125. The OBD device 105 may not include a cellular transceiver and may, instead, have a short-range wireless transceiver, e.g., a Bluetooth transceiver, for communicating with mobile device 115 via short-range wireless network connection 110. When the OBD device 105 communicates information via the short-range wireless network 110, the mobile device 115 is used to provide communication via the wireless network 125. In one exemplary embodiment, an OBD application 120 on a mobile device 115 may be used in order to collect and communicate UBI and location data through the wireless network 125. In one exemplary embodiment, the OBD 105 or the OBD application 120 may be used to collect data about applications being used on the mobile device 115. The mobile device 115 may be a smartphone, tablet, or other wireless communication device.

OBD data is communicated from the OBD device 105 or the mobile device 115 through wireless network 125 and through one of many available telecommunications networks 132 (wired and wireless) or the Internet 130 to risk profile application 140 at a server 135. In one exemplary embodiment, the OBD data can be communicated from one of the devices 105 or 115 through the wireless network 125 over the Internet to a risk profile application 150 accessible via cloud computing network 145.

Various API data providers 155 can provide data to the risk profile application 140, 150 via the Internet 130. API data that can be provided includes, but is not limited to, weather, traffic, black spot, POI, and crime.

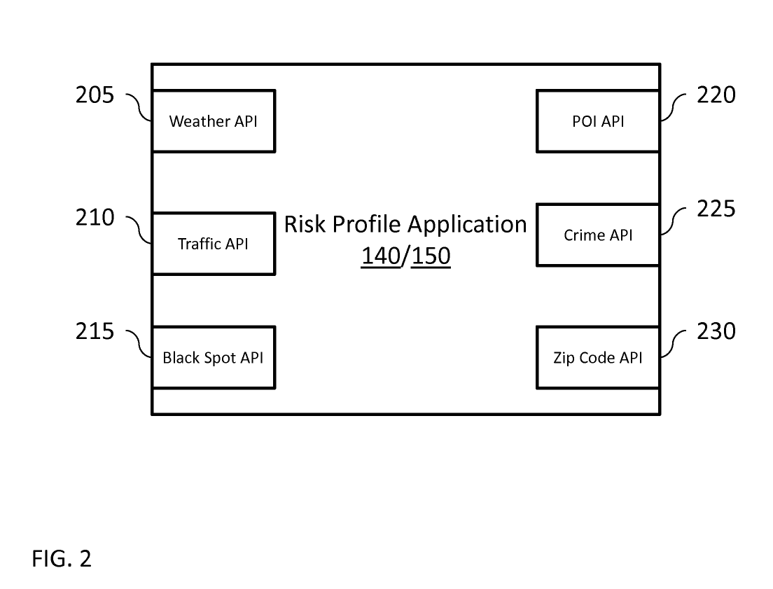

FIG. 2 illustrates various APIs associated with the risk profile application 140, 150. In this exemplary embodiment, weather API 205, traffic API 210, black spot API 215, POI API 220, crime API 225, and zip code API 230 are shown.

In one exemplary embodiment, the weather API 205 can be an API provided by the National Oceanic and Atmospheric Association (NOAA), which gives historic/current/future weather conditions by the hour for current zip code. Real-time radar mapping can augment the resolution of this zip code information in order to provide very localized knowledge. A relational database obtains GPS coordinates and using the API, associates the GPS coordinates with weather conditions.

In one exemplary embodiment, the driver's global positioning system (GPS) coordinates are determined, e.g. from the OBD 105 or the mobile device 115. A zip code API 230 determines a zip code associated with the GPS coordinates. The zip code and the time of day are, then, entered into the NOAA API in order to obtain historic/current/future weather conditions.

Traffic data can also be taken into account via the traffic data API 210. A relational database obtains GPS coordinates for a car and its route. The GPS coordinates are assigned to a location on a road by matching GPS coordinates to a map database. Each section or segment of the road has an associated traffic speed. This associated traffic speed can be used as one indicator to determine whether the driver is driving safely relative to other drivers.

Black spot data can be collected through the black spot API 215 by roadside assistance providers (e.g., towing companies) who log the location of the accident and tow the vehicle away. Black spot data can also be obtained from police or other emergency responders.

POI data can be obtained and associated with the risk profile application 140, 150 via the POI API 220. The POI data can be obtained to determine where users actually drive. POI data can also be used to measure driving behavior and/or detect travel patterns.

The risk profile application 140, 150 can obtain crime data through a crime API 225 in order to associate crime data with location-based risk. Crime data can be obtained from police reports. Crime data can also be obtained from claim loss reports used by insurance companies. Example claim loss databases that may be accessible through the crime API 225 are the A-Plus Report and the Comprehensive Loss Underwriting Exchange (CLUE).

Mileage and time of day the vehicle is driven are the cornerstones of effective UBI data. Advantages of providing effective UBI data include being able to correlate the type of road the vehicle is traveling and correlate it with accident-per-mile statistics, to validate vehicle mileage without relying on driver estimates, and to confirm where the vehicle is parked every day and night. Driver behavior patterns can be monitored over a period of time. Example driver behavior patterns primarily entail whether speed is being exceeded, whether driving takes place at an unusual time, acceleration, seat belt usage, hard braking and maintenance alerts. In addition, cornering, lane changes, and overall vehicle operating performance or health can be monitored.

Different embodiments of the invention may be implemented using different combinations of software, firmware, and/or hardware. Thus, the techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for determining a risk profile of a driver of a vehicle using improved driver metrics, which comprises:
determining driver characteristics of a driver as the driver encounters one or more locations that have an associated weighted accident history; and
comparing the determined driver characteristics of the driver to a normal distribution curve of driving characteristic data at one or more of the locations encountered by the driver.

2. The method of claim 1, wherein the determined characteristics of the driver comprise at least one of speed, time of day, acceleration, braking, an amount of times that brakes are used, and an amount of times that the driver accelerates.

3. The method of claim 1, wherein the normal distribution curve accounts for current or historical weather conditions at the one or more locations.

4. The method of claim 1, wherein the normal distribution curve accounts for traffic conditions at the one or more locations.

5. The method of claim 1, which further comprises determining driver competence by providing a comparison of driver characteristics of the driver with driver characteristic data of different drivers in similar situations.

6. The method of claim 1, which further comprises determining driver competence by providing a comparison of driver characteristics of the driver in different weather conditions.

7. The method of claim 1, which further comprises giving the driver advance warning of bad driving conditions.

8. The method of claim 7, which further comprises examining the driver characteristic data of the driver to determine whether driving behavior of the driver changes based on the advance warning.

9. The method of claim 1, which further comprises obtaining positional information of the vehicle.

10. The method of claim 9, which further comprises associating weather data with the positional information of the vehicle.

11. The method of claim 9, which further comprises associating traffic data with the positional information of the vehicle.

12. The method of claim 1, which further comprises classifying accidents of the weighted accident history by frequency or type to determine severity ratings.

13. The method of claim 12, wherein the severity ratings are a function of variables including whether the accidents of the accident history are at least one of driver-caused, related to weather, and related to distracted driving.

14. The method of claim 1, which further comprises using the weighted accident history to determine metrics for a route.

15. The method of claim 1, which further comprises collecting data using a mobile device of the driver.

16. The method of claim 15, which further comprises using the collected data to determine whether the driver is distracted.

17. The method of claim 1, which further comprises:
determining a weighted accident history for the one or more locations; and
determining the normal distribution curve for driving characteristic data of a plurality of drivers at each of the one or more locations.

18. A method for providing improved driver metrics, which comprises:
determining a weighted accident history for one or more locations; and
determining a normal distribution curve for driving characteristic data of a plurality of drivers at each of the one or more locations.

19. The method of claim 18, wherein the driving characteristic data comprises at least one of speed, time of day, acceleration, braking, an amount of times that brakes are used, and an amount of times that that the drivers accelerate.

20. The method of claim 18, which further comprises carrying out the normal distribution curve determining step by having the normal distribution curve account for weather conditions at the one or more locations.

21. The method of claim 18, which further comprises carrying out the normal distribution curve determining step by having the normal distribution curve account for traffic conditions at the one or more locations.
